(19) United States
(12) Patent Application Publication
(10) Pub. No.: US 2006/0021235 A1
(43) Pub. Date: Feb. 2, 2006

(54) Electronic appliance indicating inclination

(76) Inventor: Christian Guy Louis Becker, Francheville (FR)

Correspondence Address: MCCRACKEN & FRANK LLP, 200 W. ADAMS STREET, SUITE 2150, CHICAGO, IL, 60606, US

(21) Appl. No.: 11/231,258

(22) Filed: Oct. 20, 2005

Related U.S. Application Data
(63) Continuation of application No. 10/521,883.

(30) Foreign Application Priority Data
Jul. 18, 2003 (WO) PCT/FR03/02282
Jul. 19, 2002 (FR) FR 02/09278

(51) Int. Cl. G01C 1/00

(52) U.S. Cl. 33/282; 33/285

(57) ABSTRACT

The invention concerns an appliance indicating the inclination of a device along two spatial directions said appliance being designed to be associated with the device, and comprising a housing wherein are arranged: a first instantaneous inclination sensor for measuring a first inclination value, a second instantaneous inclination sensor for measuring a second inclination value, an electronic processing unit. The invention is characterized in that said electronic processing unit is designed to store set point values, and to compare them respectively with the measured inclination values, and to compute calculated inclination values which correspond to values of the difference between the measured inclination values and the set point values, said inclination sensors comprising semiconductor electronic accelerometer type sensors. The invention applicable to an inclination indicator.

This invention comes within the general technical sphere of spatial tiltmeters of a device according to two directions of the orthogonal space between them, the instrument being intended to be connected temporarily or otherwise to the device of which the tilt needs to be measured.

This invention more particularly concerns a tiltmeter of a device comprising:
a first instantaneous tilt sensor for measuring a first tilt value in relation to the direction of the acceleration of gravity, in the plane defined by the direction of the acceleration of gravity and the first direction of the space,
a second instantaneous tilt sensor for measuring a second tilt value in relation to the direction of the acceleration of gravity, in the plane defined by the direction of the acceleration of gravity and the second direction of the space,
an electronic processing unit comprising a microprocessor, operationally connected to the first and second tilt sensors.

The invention also comprises a process for determining the tilt of a device according to a first and second directions of the orthogonal space between them, in which is implemented:
a first measurement (a) phase of a first tilt value in relation to the direction of the acceleration of gravity, in the plane defined by the direction of the acceleration of gravity and the first direction of the space,
a second measurement phase (b) of a second tilt value in relation to the direction of the acceleration of gravity, in the plane defined by the direction of the acceleration of gravity and the second direction of the space, phases (a) and (b) being carried out simultaneously, with the aid of a first and a second instantaneous tilt sensors.

The invention also concerns a system for detecting and recording the tilt of a pylon-type superstructure.

Lastly, the invention concerns a process for monitoring the tilt of a pylon-type superstructure, according to a first and second directions of the orthogonal space between them.

Previous Techniques

The use of instruments capable of measuring and showing the value of the tilt of a device according to two directions of space is already known. Such instruments are widely known and used in various industrial fields, and particularly for measuring the tilt of devices such as industrial robots, boats or construction machinery.

Such instruments employ a case equipped with two pendular-type tilt sensors, freely mounted in rotation around a first axis, the said sensors and their first axes respectively each being mounted on a second axis orthogonal to their first axis, on the fixed and solid supports of the case.

These instruments also comprise an electronic component making it possible to store and then process the tilt data obtained in the form of electric signals from the sensors, in order to convert it into intelligible data for the user.

These familiar instruments are generally satisfactory, but are of a relatively complex design, involving numerous rotating parts, which leads to the existence of numerous resistant connections, of tribological origin, even to seizing up, which damages the instrument's reliability, and particularly its accuracy.

In addition, the pendular character of the sensors employed by these instruments involves the necessity of reserving these sensors sufficient space corresponding to their maximum balancing amplitude, which does not coincide with the miniaturization desired by the users, and which proves essential in some applications.

Moreover, such pendular sensors, when they are subjected to a change of position, are likely to oscillate for some time around their position of equilibrium before stabilizing on it, for obvious mechanical reasons linked to their inertia.

Such oscillation naturally has an adverse effect on the instrument's response time.

Electromagnetic stabilizing devices have been proposed for these pendular sensors, but apart from the fact that they require additional volume incompatible with the miniaturization of the instrument, they also create the need to carry out additional correction calculations of the tilt values measured, which complicates the electronic components as well as the calculation algorithms, which represents an additional risk factor for the operational reliability, and which increases the production costs of such an instrument.

Furthermore, it is known that numerous superstructures, particularly those engineering structures situated out of doors, such as pylons, hydraulic dams, viaducts, or some office buildings, require inspection of their spatial positioning.

Indeed, if we take the example of pylons carrying high or very high tension electric cables, these are subject to all sorts of environmental constraints, represented by the wind for example, or snow, or again by possible land subsidence. These environmental constraints, which are particularly severe in mountainous regions, require accurate inspection of the spatial positioning of the pylon, in order to reveal in time any possible changes in the spatial tilt of the pylon, so as to make it possible to take action before it collapses or tilts even further, which would prevent it fulfilling its function of carrying electric cables.

At the present time, such inspection is practiced by periodically dispatching a technician to the pylon in order to measure, with the aid of a theodolite-type instrument placed systematically in the same place in relation to the pylon, any possible change in the bidirectional tilt of the pylon. Such an operation is particularly long and painstaking, and is relatively imprecise since it is not always possible for the technician to find the exact spot for positioning his theodolite again, especially after a snowfall. In addition, the complex nature of the operation multiplies the risk of human errors concerning the tilt measurements.

### EXPLANATION OF THE INVENTION

The aims assigned to this invention are consequently to provide a new tiltmeter of a device according to two directions of the orthogonal space between them, as well as a new process for determining the tilt of a device according to two directions of the orthogonal space between them, which does not present the engineering inconveniences listed previously, and which makes it possible to obtain extremely accurate and fast tilt data while being of a simple, robust and miniaturized design.

Another aim of the invention is to propose a new tiltmeter instrument as well as a new process for determining the tilt, which could be carried out with the aid of especially reliable, inexpensive and small size components.

Another aim of the invention is to propose a new tiltmeter instrument as well as a new process for determining the tilt, permitting excellent repeatability of measurement in time, independently of environmental conditions.

Another aim of the invention is to propose a new tiltmeter instrument as well as a new process for determining the tilt which would have general application and could be adapted to various technical fields of application.

Another aim of the invention is to propose a new tiltmeter instrument as well as a new process for determining the tilt which will permit particularly easy reading of the results, even in difficult practical configurations.

Another aim of the invention is to propose a new tiltmeter instrument as well as a new process for determining the tilt that will clearly show an absence of hysteresis.

Another aim of the invention is to propose a new tiltmeter instrument as well as a new process for determining the tilt that could be adapted to the monitoring, inspection or control applications in time of the tilt of a device according to two directions of space.

Another aim of the invention is to propose a new tiltmeter instrument as well as a new process for determining the tilt making excellent accuracy of measurements possible.

Another aim of the invention is to propose a new tiltmeter instrument as well as a new process for determining the tilt making it possible to correlate the tilt of a device under meteorological conditions.

Another aim of the invention is to propose a new tiltmeter instrument as well as a new system for detecting and recording the tilt of a superstructure as well as a new process for monitoring the tilt of a superstructure, which is simply implemented by obtaining accurate results, and which reduces the operating costs and constraints.

Another aim of the invention is to propose a new tiltmeter instrument as well as a new system for detecting and recording the tilt of a superstructure as well as a new process for monitoring the tilt of a superstructure, making it possible to process the time-stamped tilt data over a long period of time in a swift and automated fashion.

The aims assigned to the invention are achieved with the aid of a tiltmeter of a device according to a first and second directions of the orthogonal space between them, the said instrument being intended to be placed on, attached to or integrated into the device, and comprising:
a first instantaneous tilt sensor for measuring a first tilt value in relation to the direction of the acceleration of gravity, in the plane defined by the direction of the acceleration of gravity and the first direction of the space,
a second instantaneous tilt sensor for measuring a second tilt value in relation to the direction of the acceleration of gravity, in the plane defined by the direction of the acceleration of gravity and the second direction of the space,
an electronic processing unit comprising a microprocessor, operationally connected to the first and second tilt sensors.
   characterized on the one hand by the said first and second instantaneous tilt sensors as well as the electronic processing unit being arranged in the same case, and on the other by the said electronic processing unit being arranged in such a way as to store a first and second reference values, and to compare them with the first and second tilt values measured, and to display simultaneously, by means of visualization, the tilt values calculated which correspond to the values of the difference between the tilt values measured and their respective reference values, the said tilt sensors comprising semi-conductor electronic sensors of the accelerometer type.

The aims assigned to the invention are achieved with the aid of a process for determining the tilt of a device according to a first and second directions of the orthogonal space between them, in which is implemented:
a first measurement phase (a) of a first tilt value in relation to the direction of the acceleration of gravity, in the plane defined by the direction of the acceleration of gravity and the first direction of the space,
a second measurement phase (b) of a second tilt value in relation to the direction of the acceleration of gravity, in the plane defined by the direction of the acceleration of gravity and the second direction of the space, phases (a) and (b) being carried out simultaneously, with the aid of a first and a second instantaneous tilt sensors.
   characterized by comprising:
a memorization phase (c) of a first and second reference values,
a comparison phase (d) of the said first and second reference values to the first and second tilt values measured,
a calculation phase (e) of the tilt values calculated which correspond to the values of the difference between the tilt values measured and their respective reference values, the said instantaneous tilt sensors comprising semi-conductor electronic sensors of the accelerometer type and being integrated into one single electronic chip.

### SUMMARY SPECIFICATIONS OF DRAWINGS

Other details and special advantages of the invention will be better understood with the aid of the specification which follows, accompanied by the drawings appended, given purely for unlimited illustrative purposes in which:

FIG. 1 illustrates, in perspective, a tiltmeter as the invention.

FIG. 2 illustrates, from above, the tiltmeter represented in FIG. 1.

FIG. 3 illustrates, in diagrammatic form, a tiltmeter as the invention being used in the context of an application of monitoring and recording of the spatial tilt of an electric pylon.

FIG. 4 illustrates diagrammatically an example of the relative positioning of the direction of the acceleration of gravity, with both directions of the space according to which the tilt is measured, as well as both directions of the space corresponding to the reference values.

### BEST WAY OF EMPLOYING THE INVENTION

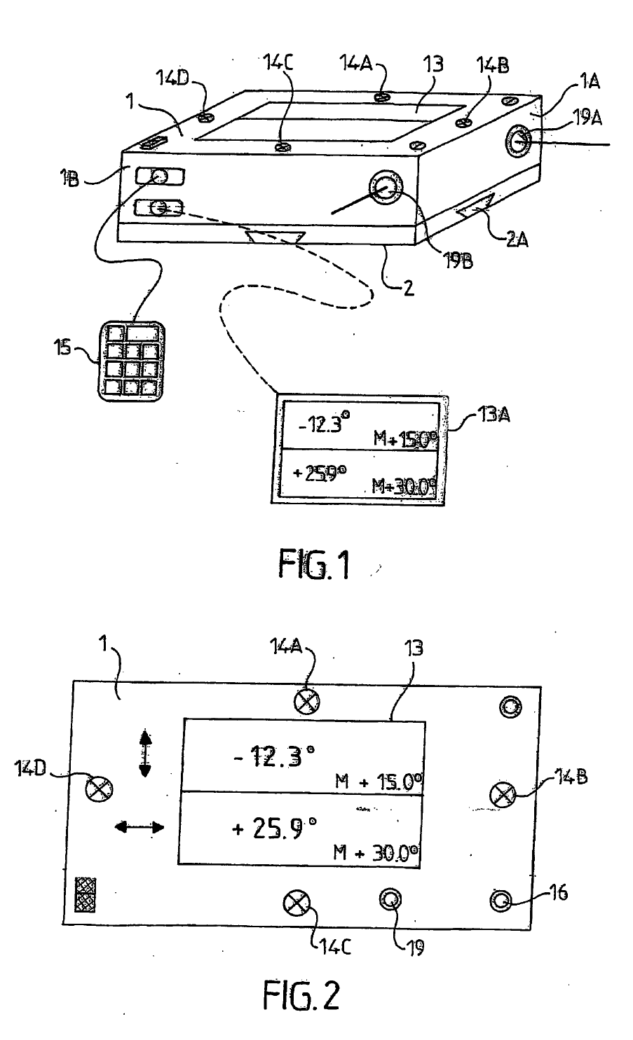

As shown in FIGS. 1 and 2, the instrument as the invention is helpfully presented in a case 1, for example metallic or in general notably box-shaped, with a noticeably flat base 2 intended to be placed on, attached to or integrated into a device 22, of which it is to measure the spatial position or tilt, according to a first and second directions of the orthogonal space 3, 4 between them, that is to say, making an angle equal to 90°.

In terms of the invention, the expression ‘device’ means such varied and unlimited items as portable apparatuses for domestic use (help with the height of hedges or consumer do-it-yourself articles such as drills), portable apparatuses for professional use (building, carpentry, masonry, pipe laying, false ceilings, tiling, interlocking sett paving, boring, lateral leveling of miscellaneous furniture, pianos, billiard tables, casino machines, roundabouts even machine tools, track laying, etc.), setting of dentures or instruments in the medical field, fixing of parabolic aerials, etc. The tiltmeter invention can also be integrated or mounted in a vehicle such as a caravan, camping car, motorized garden machine, boat, cycle, airplane or car, or again in a public works or agricultural machine, without any restriction.

Another application envisaged for the tiltmeter invention, given for unlimited illustrative purposes, consists of integrating the tiltmeter in a position control system, with the aim of controlling a tripod or other support element in relation to a reference, permanently or to order.

According to the invention, the tiltmeter comprises:
a first instantaneous tilt sensor for measuring a first tilt value 8 in relation to the direction of the acceleration of gravity 5, in the plane defined by the direction of the acceleration of gravity 5 and the first direction of the space 3,
a second instantaneous tilt sensor for measuring a second tilt value 9 in relation to the direction of the acceleration of gravity 5, in the plane defined by the acceleration of gravity 5 and the second direction of the space 4.

The direction of the acceleration of gravity 5 here corresponds to the direction of the vector g also sometimes called the intensity of gravity. This direction corresponds to the direction of the force which constitutes the weight.

In practice, the first and second directions of space 3, 4 each make a 90° angle with the direction of the acceleration of gravity 5.

The said first and second instantaneous tilt sensors are one-dimensional tilt sensors and are arranged to remain fixed solidly to the inside of the case 1 noticeably against the base 2, and thus form a bi-dimensional instantaneous tilt sensor.

Depending on the possible operating mode of the invention, the tiltmeter can also comprise, inside the case 1, a second bi-dimensional instantaneous tilt sensor.

Advantageously, the second bi-dimensional instantaneous tilt sensor is fixed solidly on the first bi-dimensional instantaneous tilt sensor formed by the first and second instantaneous tilt sensors.

Depending on the special operating mode, the second bi-dimensional instantaneous tilt sensor is formed by the arrangement of a third and fourth instantaneous tilt sensors, one-dimensional, positioned in the space in such a way that when the first and/or second instantaneous tilt sensors measure the tilt values 8, 9 greater than 45°, the third and/or fourth instantaneous tilt sensors measure the tilt values less than 45° (and inversely). In particular, when the first and/or second instantaneous

tilt sensors measure the tilt values 8, 9 between 0° and 45°, the third and fourth instantaneous tilt sensors measure the tilt values between 45° and 90°.

Very conveniently, the third instantaneous tilt sensor is noticeably mounted orthogonally in relation to the first instantaneous tilt sensor so that the tilt values measured on the one hand by the first sensor and on the other by the second sensor are complementary, that is to say their sum amounts to 90°.

In a similar fashion, the fourth instantaneous tilt sensor is for preference noticeably mounted orthogonally in relation to the second instantaneous tilt sensor.

In this operating mode, the instrument only takes account of the tilt values measured by the instantaneous tilt sensors that are less than 45°.

As an unlimited illustration, if the first instantaneous tilt sensor measures a tilt value greater than 45°, in particular between 45° and 90°, this latter is not taken into account. It is the additional tilt value between 45° and 90° measured by the third instantaneous tilt sensor that is taken into account.

In a particularly convenient fashion, all the instantaneous tilt sensors have noticeably identical characteristics compared one with another, so that the error made by each instantaneous tilt sensor will be less that 2% of a degree within the actual working range of the said sensor corresponding to the tilt values included between 0° and 45°.

Thus, the assembling of the first and second bi-dimensional instantaneous tilt sensors in relation to one another is carried out in such a way that the instrument can measure with noticeably constant accuracy the tilt of the device within all the range of tilt angles between 45° and 90°, and do this with an error factor of less than 2% of a degree.

In the continuation of the specification, the tilt values measured 8, 9 are considered as resulting from the measurements carried out by the first and second instantaneous tilt sensors, once the tilt of the device according to the first and second direction of the space is less than 45°.

Conversely, once the tilt of the device according to the first and second direction of the space is greater than 45°, the tilt values measured 8, 9 are considered as resulting from the measurements carried out by the third and fourth instantaneous tilt sensors.

Such a coupling of two bi-dimensional instantaneous tilt sensors is especially useful when complete accuracy of the measurements is required, particularly in the field of pointing aerials.

According to the invention, the tiltmeter also includes, inside the case 1, an electronic processing unit comprising a microprocessor, operationally connected to the first and second tilt sensors.

Conveniently, the electronic processing unit includes an electronic card connected to a microprocessor. As an example, this microprocessor can be a microcontroller with a read only memory of 8 kilobytes and a read/write memory of 256 bytes.

In accordance with the invention, the said electronic processing unit is designed and arranged in such a way as to store a first and second reference values 6, 7, and to compare them with the first and second tilt values measured 8, 9, and to calculate the tilt values calculated 10, 1I which correspond to the values of the difference between the tilt values measured 8, 9 and their respective reference values 6, 7.

The reference values 6, 7 thus form a reference plan 12 in relation to which the instrument's recording plan is evaluated, which could for example be assimilated into the base 2.

According to the invention, the first and second instantaneous tilt sensors comprise semi-conductor electronic sensors of the accelerometer type, used here as inclinometers. Conveniently, such sensors comprise two polysilicon plates suspended by multiple springs in relation to the corresponding polysilicon plates fixed to a silicon substratum so as to form two parallel condensers. The first polysilicon plate is suspended by flexible springs so as to form a variable capacity condenser. The second polysilicon plate is suspended by rigid springs so as to form a fixed capacity condenser. The acceleration is measured by comparing the variable capacity with the fixed capacity during the acceleration.

Conveniently, the first and second tilt sensors are integrated orthogonally into a single electronic chip, so as to form a monobloc component

In a particularly convenient fashion, the third and fourth instantaneous tilt sensors are also integrated into this single electronic chip,

in an orthogonal fashion to the first and second instantaneous tilt sensors. In this way, the first and second bi-dimensional tilt sensors are arranged so as to form a monobloc component.

Such semi-conductor inclinometer sensors make it conveniently possible to deliver an electric signal whose tension is between 0 and 5V and which is proportional to the angle (or to its sine, cosine or tangent) measured.

We thus conveniently use a miniaturized tilt sensor perfectly and completely bi-directional by construction, operational in all directions.

Conveniently, the sensor is positioned on and connected to the electronic processing unit.

For preference, the electronic processing unit is bathed in a protective resin, so as best to preserve it from any outside attack.

Conveniently, the instrument comprises at least one means of visualization 13, 13A, 14A-D of the data resulting from the measurements carried out by the first and second sensors, the said means of visualization being operationally connected to the electronic processing unit, so as to display simultaneously the tilt values calculated 10, 11, or the values deducted from these values calculated, by additional arithmetical or trigonometrical operations.

In a convenient way, the means of visualization comprises a digital screen 13, 13A, possibly backlit, making reading easier.

According to the invention, the tilt values calculated 10, 11 are displayed directly by the means of visualization and by the combined digital screen 13, 13A.

According to a variant of the invention, the means of visualization comprises buttons 14A-D capable of being illuminated for signaling, by activation, the direction of the difference of the tilt of the device in relation to at least one reference value 6, 7.

Conveniently, the case 1 comprises on a same face, and for preference on the face including the means of visualization 13, four buttons 14A-D symmetrically opposed in pairs in order to display and visualize four differences of tilt.

According to an operating variant illustrated in FIG. 1, the case 1 can be combined with an external means of visualization 13A which is operationally connected, temporarily or otherwise, to case 1 by wire or radio link, so as to permit a remote reading of the tilt data. Indeed, in certain practical configurations, it can be interesting to be able to inspect and read the tilt data given by the instrument at a distance.

According to a variant of the invention, the instrument comprises an external keyboard 15 connectable to the electronic processing unit (by wire or radio link), via an interface on case 1, in order to enter the reference values 6, 7.

In general, the case 1 will be provided with an element 16 permitting the memorization of the reference value(s) 6, 7 chosen. For preference, when the user wishes to memorize one or more reference values 6, 7, he inclines the case 1 in a stable manner according to the directions required 17, 18, then records and stores the value(s) thus automatically measured by activating button 16.

Conveniently, the instrument comprises a system for the auto-calibration of the reference values making it possible to return to reference value 6, 7 equal to zero.

In use, and in the event for example of a case 1 which is not integrated in a device, the user activates, for example before the measurement, a button 19 for automatic return to zero corresponding to a reference tilt of zero gravity, which in reality deletes the last reference value(s) 6, 7 stored in the memory of the electronic processing unit

The user then places the case 1 on the surface on which he wishes to measure the tilt(s), the means of visualization 13, 13A, 14A-D then showing simultaneously the slopes according to directions 3 and 4.

The tilt measurement is therefore immediate and can moreover then be memorized to form a couple of reference values 6, 7 in relation to which later tilts will be measured.

In the event where case 1 is integrated in a vehicle or other device, the principle for the reading is identical.

Conveniently, the base 2 will moreover be provided with a magnetic metal sole, equipped for example with dovetails 2A, in order to permit the introduction of rulers or set squares for the purpose of additionally carrying out tilt measurements over great lengths.

Conveniently, the case 1 can be equipped with elements of laser sights 19A, 19B mounted for example on the lateral faces 1A, 1B. The elements of laser sights 19A, 19B make it possible to carry out a visual marking at a distance representative of the reference tilt given by the case 1 itself, and in two directions for example, and therefore according to a plane that is thus visually materialized. In some applications, particularly in the construction industry, this visual marking of a plane and at a distance can prove extremely useful.

According to the invention, the tiltmeter is also provided with a meteorological station comprising one or more instruments, such as a frost detector, an anemometer, a thermometer and one or more optical sensors. The meteorological data detected by these instruments will for preference be stored in a non-volatile memory, and then exported to a computer reader to be processed there. In particular, the meteorological data and the tilt data can be compared so as to identify a possible correlation between the tilt data and the meteorological data.

Conveniently, the instrument is also provided with a signaling system capable of forbidding or permitting work to take place on the device, and for example on a pylon. If therefore the anemometer shows a wind speed that is too high, a red warning light will come on, so as to stop anyone climbing the pylon in order to undertake a repair.

A meteorological station is also useful for the purpose of determining the maximum external constraints supported by an aerial, that is to say the constraints which lead to a tilt of the aerial such as is likely to affect its transmission and reception qualities.

Conveniently, the instrument comprises a non-volatile memory unit operationally connected to an electronic processing unit, so as to store the tilt values calculated

This non-volatile memory unit, which forms a backup memory, can for example be made up of an FFPROM type memory. A magnetic memory is also possible. This memory unit also makes it possible to save an historical record of the different tilt values calculated, with a view to subsequent processing.

Conveniently, the instrument comprises a real time clock which delivers a signal representing the instantaneous date and time. This real time clock allows the measuring instrument to know the exact date and time. This real time clock also stores at least one predetermined date and time, and is operationally connected to the electronic processing unit so that this latter compares the instantaneous date and time with the predetermined date and time, and if they are both equal, proceeds to the time-stamped storage in the non-volatile memory of the tilt values calculated at that instant.

This clock also makes it possible, in combination with a memory unit, to carry out preprogrammed measurement recordings.

Conveniently, the instrument comprises an out-connector, positioned for example to one face of the case 1, and operationally connected to the electronic processing unit, so as to be able to connect the instrument to a computer-type reader 21, with a view to exporting to this latter the time-stamped data contained in the non-volatile memory.

It is also possible to connect the instrument to a computer-type reader 21, with a view to exporting data to the tiltmeter, such as for example the predetermined dates and times of storage of tilt values, or again reference values.

It is also possible to connect the instrument to the Internet, so as to authorize import and/or export data operations with the aid of a remote computer.

The instrument also involves a process for determining the tilt of a device according to a first and second directions of the orthogonal space 3, 4 between them, in which is implemented:
a first measurement phase (a) of a first tilt value 8 in relation to the direction of the acceleration of gravity 5, in the plane defined by the direction of the acceleration of gravity 5 and the first direction of the space 3,
a second measurement phase (b) of a second tilt value 9 in relation to the direction of the acceleration of gravity (5), in the plane defined by the direction of the acceleration of gravity 5 and the second direction of the space 4, phases (a) and (b) being carried out simultaneously,
a memorization phase (c) of a first and second reference values 6, 7, this memorization phase (c) generally taking place before phases (a) and (b),
a comparison phase (d) of the said first and second reference values 6, 7 to the first and second tilt values measured 8, 9,
a calculation phase (e) of the tilt values calculated 10, 11, which correspond to the values of the difference between the tilt values measured 8, 9 and their respective reference values 6, 7.

Phases (a) and (b) are carried out simultaneously, with the aid of a first and a second instantaneous tilt sensors, the said instantaneous tilt sensors comprising semi-conductor electronic sensors of the accelerometer type, which are both conveniently integrated into one single electronic chip, so as to form an electronic and miniaturized monobloc component.

In the invention, phases (a) and (b) can also be carried out with the aid of a third and a fourth instantaneous tilt sensors, these latter being of the same type as the first and second instantaneous tilt sensors. Therefore, once the tilt of the device according to the first and second directions of the space exceeds 45°, it is the measurement carried out by the third and fourth instantaneous tilt sensors that is taken into account.

Conveniently, the third and fourth instantaneous tilt sensors are arranged orthogonally in relation to the first and second instantaneous tilt sensors.

Conveniently, such a process makes it possible to measure the tilt of a device within all the range of tilt angles between 0° and 90°, while preserving a noticeably constant error factor of less than 2% of a degree, thanks to the coupling of instantaneous tilt sensors two by two.

Conveniently, the process of determining the tilt according to the invention also comprises a display phase (f) of the tilt values calculated 10, 11, the said values being displayed in a simultaneous fashion.

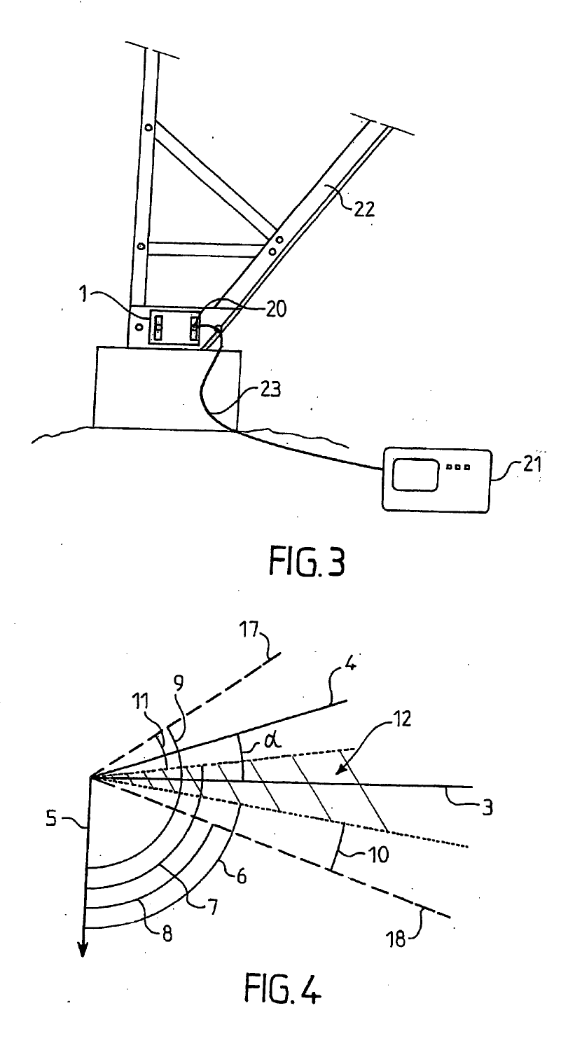

All of this is represented in FIG. 3, the invention also involves a system for detecting and recording in real time the tilt of a pylon-type superstructure. In the invention, the term ‘superstructure’ notably means any construction works or engineering structures, whatever their height, geometry and dimensions. The term superstructure particularly means slender structures such as masts, lighting columns, posts or electric pylons.

The system for detecting and recording the tilt of a pylon-type superstructure 22 according to the invention comprises, on the one hand, a tilt meter endowed with a non-volatile memory and a real time clock in conformity with the invention, the said instrument being arranged to be fastened to the superstructure 22 by any known means of fixation and, on the other, a computer-type reader 21 as well as a cable-type connection interface 23, either a cable or wireless link, permitting the computer-type reader 21 to be connected to the instrument in a portable manner in order to export the time-stamped data contained in the non-volatile memory to the computer reader.

Such a system for detecting and recording the tilt of a superstructure also permits in time inspection of the spatial position of the superstructure 22, and more precisely permits the inspection of the difference between this instantaneous spatial position and a reference position, which could particularly correspond to the initial position of the superstructure 22.

Conveniently, the system for detecting and recording the tilt according to the invention comprises a coding element permitting the superstructure 22 to be identified.

This coding element can for example be an alphanumeric sequence engraved or inscribed on the case 1, or again a bar code. This coding element can also consist of computer data stored in the instrument's processing unit.

Conveniently, the system for detecting and recording the tilt of a pylon-type superstructure 22 according to the invention comprises a computer program for processing and analyzing the time-stamped tilt data exported. This program is implemented by a computer-type data processing unit, which can correspond to computer reader 21. This program makes it possible to obtain historical data of the tilt of the superstructure, which data constitutes the data for monitoring the tilt of the superstructure. In concrete terms, this program or software makes it possible to present, in the form of a table and/or graph, the different readings of the bidirectional tilt carried out on a superstructure 22 during a given period.

The system of inspection according to the invention lends itself particularly suitably to monitoring the tilt of pylons carrying high or very high tension electric cables

The process for determining the tilt previously described can also be used to assure the monitoring of the tilt of a superstructure 22. In this case, and in a convenient fashion, the said first and second reference values 6, 7 are chosen to be representative of the initial position of the superstructure 22.

In a practical way, we can imagine for illustrative purposes that a technician fixes the case 1 to a superstructure 22, then records and stores the values thus automatically measured by activating button 16, these values automatically becoming the reference values representative of the initial position of the superstructure 22.

Conveniently, the process for the determination of the tilt, when it is used to assure the monitoring of the tilt of a superstructure 22 comprises, in addition to stages (a) to (e) or (a) to (f) previously described, the following stages:
a stage of time-stamped storage (g) in a non-volatile memory of the said tilt values calculated 10, 11, the acquisition cycle made up of stages (a) to (g) being repeated in a periodic fashion according to a frequency called an acquisition frequency,
an exporting stage (h) of the time-stamped tilt data contained in the non-volatile memory to a computer reader 21, this stage (h) being carried out in a periodic fashion on a frequency called a recovery frequency, this frequency being greater than or equal to the acquisition frequency,
a time-stamped data processing stage (i) exported with the aid of a computer program, so as to obtain in time monitoring data of the tilt of the superstructure 22.

In a particularly convenient manner, the process for the determination of the tilt also comprises:
a stage of time-stamped storage (j) in a non-volatile memory of meteorological data measured by the instruments of a meteorological station,
an export stage (k) of the said meteorological data to a computer reader 21,
a stage of comparative processing (1) of the said meteorological data and the said tilt data, so as to possibly arrive at the reasons for the tilt of the device, and for example an aerial of the type used in the world of mobile communications (aerial or GSM)

Therefore, all this data, that is the meteorological tilt data, could be represented in a graphic form so as to make it possible on the one hand to compare the curves obtained, and on the other to possibly identify the meteorological causes for the tilt of the device.

Therefore, as an example, a system for detecting and recording the tilt of a superstructure 22 according to the invention is attached to a superstructure 22, and twice a day records the spatial positioning of this superstructure 22. Each week, a technician visits the pylon and connects a computer reader 21 (for example a computer) to the case 1, so as to recover all the tilt values calculated that are time-stamped and stored in the non-volatile memory of the instrument fixed to the superstructure 22. The technician can therefore make up a databank which includes the codes identifying the superstructure(s) 22 concerned as well as the dates, times and corresponding tilt values, this data being then processed graphically or statistically, so as to analyze and provide for the space-time evolution of a superstructure 22 and warn of any fall or damage to this.

### POSSIBILITY OF INDUSTRIAL APPLICATIONS

The invention finds its industrial application in the design and manufacture of the tiltmeters of devices.

1-29. (canceled)

30. An instrument to measure the inclination of a device along a first direction and a second direction of orthogonal space, the instrument associated with the device, and the instrument comprises:
a first instantaneous inclination sensor to measure a first inclination value in relation to gravitational acceleration, in a plane defined by a direction of the gravitational acceleration and the first direction of the space;
a second instantaneous inclination sensor to measure a second inclination value in relation to the gravitational acceleration, in the plane defined by the direction of the gravitational acceleration and the second direction of the space; and
an electronic processing unit comprising a microprocessor, in communication with the first and second instantaneous inclination sensors;
wherein the first and second instantaneous inclination sensors and the electronic processing unit are arranged in the same case, and the electronic processing unit stores a first and second reference values, and compares the first and second reference values with the first and second measured inclination values, and calculates calculated inclination values that correspond to the difference between the first and second measured inclination values and the respective reference values, and wherein the instantaneous inclination sensors are semi-conductor electronic accelerometer type sensors.

31. The instrument of claim 30 wherein the first and second sensors are integrated into a single electronic chip to form a monobloc component.

32. The instrument of claim 30 further including at least one display device to display the data resulting from the measurements carried out by the first and second sensors, and wherein the display device is in communication with to the electronic processing unit, so as to display the calculated inclination values simultaneously.

33. The instrument of claim 33 wherein the display device is a digital screen.

34. The instrument of claim 33 wherein the calculated inclination values are displayed directly by the digital screen.

35. The instrument of claim 32 wherein the display device is outside the case and is operationally connected to the case by wire or radio link, to permit remote reading of the inclination data.

36. The instrument of claim 32 wherein the display device is a series of four buttons arranged in symmetrically opposed pairs in order to display and visualize four differences of inclination that can be illuminated to signal, by activation, the direction of the difference of the inclination of the device in relation to at least one reference value.

37. The instrument of claim 30 further including an external keyboard connectable to the electronic processing unit in order to enter the reference values.

38. The instrument of claim 30 further including a system for the auto-calibration of the reference values equal to zero.

39. The instrument of claim 30 further including an element permitting the memorization of the reference value(s) chosen.

40. The instrument of claim 30 further including a non-volatile memory unit operationally connected to the electronic processing unit so as to store the inclination values calculated, a real time clock delivering a signal representing the instantaneous date and time, and storing at least a predetermined date and time, the said real time clock being operationally connected to the electronic processing unit in order that this latter compares the instantaneous date and time with the predetermined date and time, and if they are both equal, proceeds to time-stamped storage of the inclination values calculated at that instant in the non-volatile memory, and a port in communication with the electronic processing unit, to enable the instrument to be connected to a computer-type reader, to export the time-stamped data contained in the non-volatile memory.

41. The instrument of claim 30 further including:
a first bi-dimensional instantaneous inclination sensor, formed by the arrangement of the first and second instantaneous inclination sensors;
a second bi-dimensional instantaneous inclination sensor, formed by the arrangement of a third and a fourth instantaneous inclination sensors; and
the said first and second bi-dimensional inclination sensors being arranged in the same case.

42. The instrument of claim 41 wherein the third and fourth inclination sensors are mounted orthogonally in relation to the first and second instantaneous inclination sensors so that the first and second instantaneous inclination sensors measure inclination values between 0° and 45°, and the third and fourth inclination sensors measure additional inclination values between 45° and 90°.

43. The instrument of claim 41 wherein the first and second bi-dimensional instantaneous sensors are integrated into a single electronic chip to form a monobloc component.

44. The instrument of claim 30 further including a meteorological station comprising one or more instruments, such as a frost detector, an anemometer, a thermometer and one or more optical sensor.

45. The instrument of claim 30 further including a pylon-type signaling system capable of forbidding or permitting interference with the device.

46. A process for determining the inclination of a along a first direction and a second direction of orthogonal space, the process including the steps of:
a) measuring a first inclination value in relation to gravitational acceleration, in a plane defined by a direction of the gravitational acceleration and the first direction of the space;
b) measuring a second inclination value in relation to gravitational acceleration, in a plane defined by a direction of the gravitational acceleration and the second direction of the space;
wherein steps (a) and (b) are carried out simultaneously, with the aid of a first and a second instantaneous inclination sensors;
c) memorizing a first and second reference values;
d) comparing the first and second reference values to the measured first and second inclination values; and
e) calculating calculated inclination values that correspond to the difference between the measured inclination values and their respective reference values;
wherein the instantaneous inclination sensors are semi-conductor electronic sensors of the accelerometer type and are integrated into one single electronic chip.

47. The process of claim 46 wherein the said first and/or second inclination values are greater than 45°, and wherein at least one of the measuring of the first inclination value and the measuring of the second inclination value are carried out with the aid of a third and/or fourth instantaneous inclination sensors, arranged orthogonally in relation to the first and second instantaneous inclination sensors.

48. The process of claim 46 further including the step of:
f) displaying the calculated inclination values.

49. The process of claim 46 wherein the determination of the inclination is used to monitor of the inclination of a superstructure, wherein the said first and second reference values are representative of an initial position of the superstructure.

50. The process of claim 48 further including the step of:
g) storing in a non-volatile memory a time-stamp of the calculated inclination values;
wherein an acquisition cycle steps (a) to (g) are repeated in a periodic fashion according to an acquisition frequency;
h) exporting the time-stamped inclination data contained in the non-volatile memory to a computer reader, wherein step (h) is carried out in a periodic fashion according to a recovery frequency greater than or equal to the acquisition frequency; and
i) time-stamped data processing exported using a computer program to obtain in time monitoring data of the inclination of the superstructure.

51. The process of claim 50 further including the step of:
j) time-stamped storage in a non-volatile memory of meteorological data measured by the instruments of a meteorological station;
k) exporting the meteorological data to a computer reader; and
l) comparative processing of the meteorological data and the inclination data to identify a possible correlation between the inclination data and the meteorological data.

52. A system for detecting and recording the inclination of a pylon-type superstructure comprising, an instrument of claim 37, the instrument being fastened to the superstructure, a computer-type reader, and a cable-type connection interface to enable the connection of the computer-type reader to the instrument in a portable manner in order to export time-stamped data contained in a non-volatile memory to the computer reader.

53. The system of claim 52 further including a coding element to identify the superstructure, wherein the superstructure is at least one electricity line pylon.

54. The system of claim 52 further including a computer program for processing and analyzing the exported time-stamped inclination data, the program being implemented by a data processing unit to obtain data to monitor the inclination of the superstructure.
